(19) United States
(12) Patent Application Publication
(10) Pub. No.: US 2009/0066054 A1
(43) Pub. Date: Mar. 12, 2009

(54) Reclining Cycle Having a Seat Whose Position and Inclining Angle are Adjustable

(76) Inventor: Susan Su, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/853,188

(22) Filed: Sep. 11, 2007

(51) Int. Cl. B62K 3/02

(52) U.S. Cl. 280/288.1

(57) ABSTRACT

A reclining cycle includes a frame, a fixing member mounted on a top tube of the frame, two pairs of slides slidably mounted on the fixing member, a support member mounted on the slides and having two first support brackets and two second support brackets mounted on the slides respectively, two locking members mounted between the support member and the slides to releasably lock the first support brackets and the second support brackets of the support member onto the slides, and a seat mounted on the support member. Thus, the position and the inclined angle of the seat relative to the frame can be adjusted according to a user's requirement to provide a comfortable sensation to the user when the user is seated on the seat.

### BACKGROUND OF THE INVENTION

1. Field of the Invention

The present invention relates to a cycle and, more particularly, to a reclining cycle having a seat whose position and inclining angle are adjustable.

2. Description of the Related Art

A conventional reclining cycle comprises a frame, a front wheel mounted on a front portion of the frame, a rear wheel mounted on a rear portion of the frame, and a seat mounted on the frame. The seat is inclined relative to the frame to provide a comfortable sensation to a user when the user is seated on the seat. However, the position and the inclined angle of the seat relative to the frame cannot be adjusted according to a user's requirement, thereby causing inconvenience to the user when the size of the seat does not fit the user's stature. In addition, the seat is available for the frame of the same size so that the seat is not available frames of different sizes and specifications.

### BRIEF SUMMARY OF THE INVENTION

In accordance with the present invention, there is provided a reclining cycle, comprising a frame having a top tube, a fixing member mounted on the top tube of the frame, two pairs of slides slidably mounted on the fixing member, a support member mounted on the slides to move with the slides and having a first end provided with two first support brackets adjustably mounted on a first pair of the slides and a second end provided with two second support brackets pivotally mounted on a second pair of the slides, two locking members mounted between the support member and the slides to releasably lock the first support brackets and the second support brackets of the support member onto the slides, and a seat mounted on the support member.

The primary objective of the present invention is to provide a reclining cycle, wherein the position and the inclined angle of the seat relative to the frame can be adjusted according to a user's requirement to provide a comfortable sensation to the user when the user is seated on the seat.

Another objective of the present invention is to provide a reclining cycle, wherein the support member is locked and unlocked by each of the locking members so that the position and the inclined angle of the seat relative to the frame can be adjusted easily and quickly, thereby facilitating the user adjusting the position and the inclined angle of the seat.

A further objective of the present invention is to provide a reclining cycle, wherein the lower portion of the fixing member has a bottom formed with a receiving recess to receive the top tube of the frame so that the fixing member is available for frames of different sizes.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially perspective view of a reclining cycle in accordance with the preferred embodiment of the present invention.

FIG. 2 is an exploded perspective view of the reclining cycle as shown in FIG. 1.

FIG. 3 is a side view of the reclining cycle in accordance with the preferred embodiment of the present invention.

FIG. 4 is a front cross-sectional view of the reclining cycle as shown in FIG. 1.

FIG. 5 is a schematic side operational view of the reclining cycle as shown in FIG. 1.

FIG. 6 is a schematic side operational view of the reclining cycle as shown in FIG. 1.

### DETAILED DESCRIPTION OF THE INVENTION

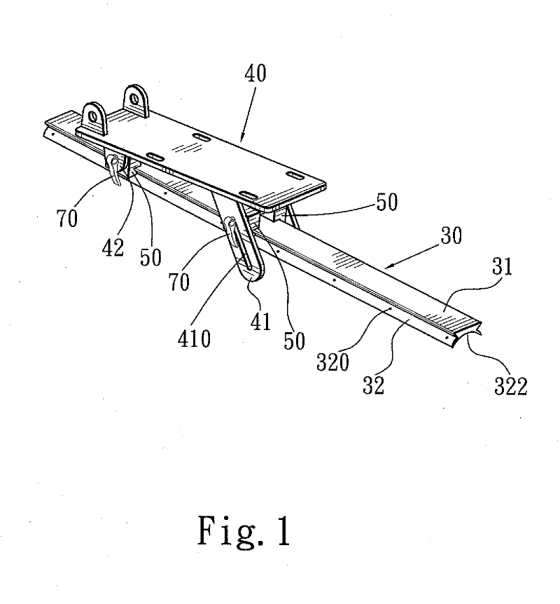

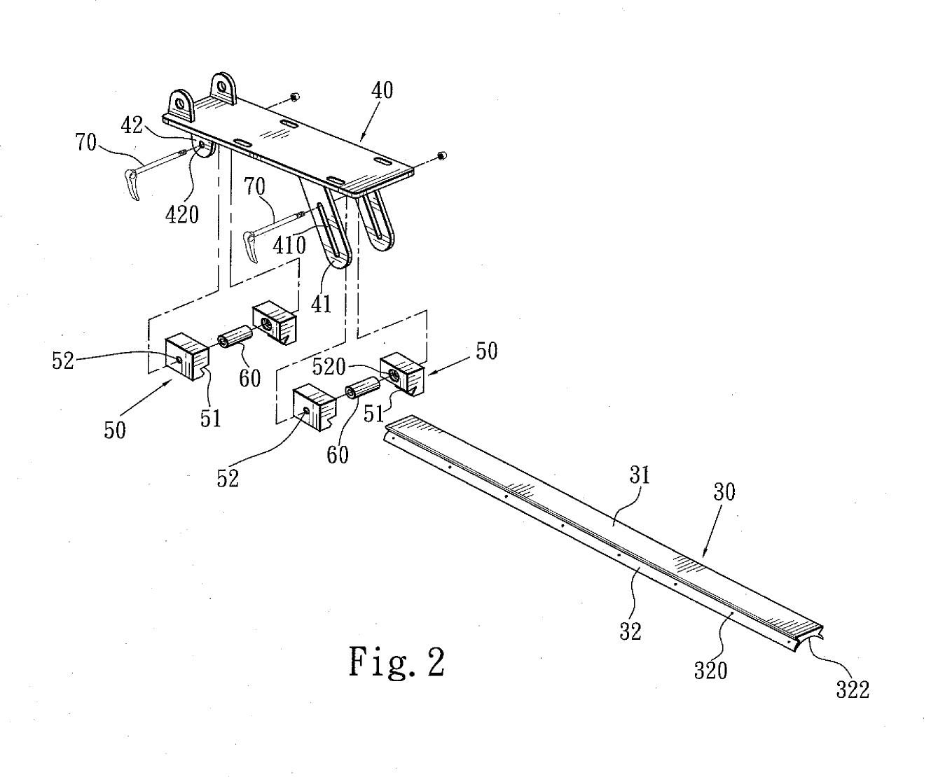

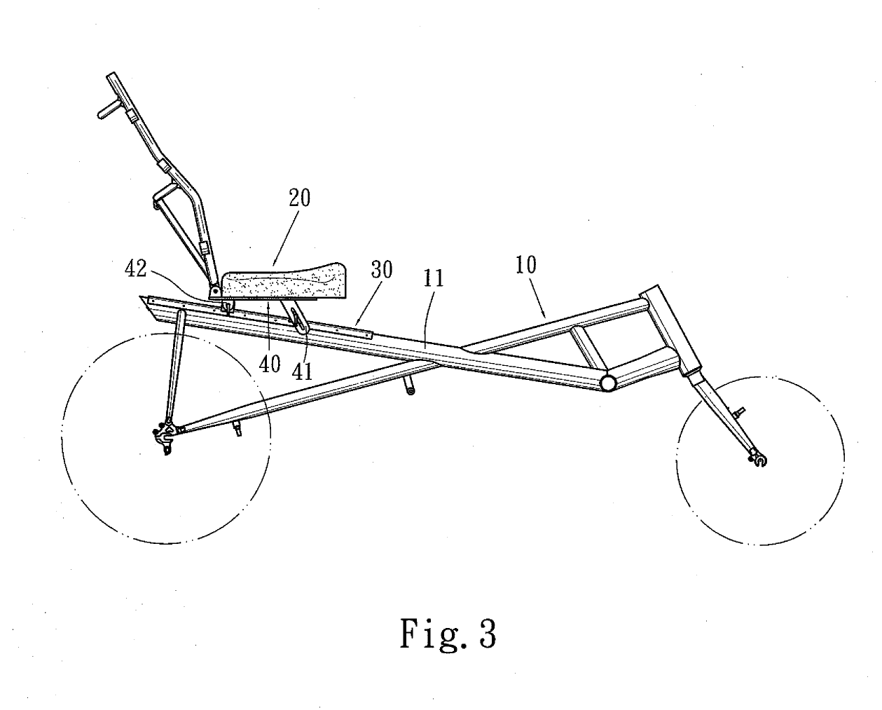

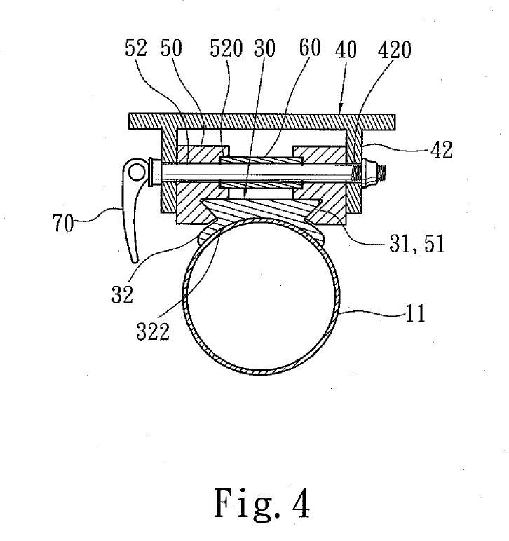

Referring to the drawings and initially to FIGS. 1-4, a reclining cycle in accordance with the preferred embodiment of the present invention comprises a frame 10 having a top tube 11, a fixing member 30 mounted on the top tube 11 of the frame 10, two pairs of slides 50 slidably mounted on the fixing member 30, a support member 40 mounted on the slides 50 to move with the slides 50 and having a first end provided with two first support brackets 41 adjustably mounted on a first pair of the slides 50 and a second end provided with two second support brackets 42 pivotally mounted on a second pair of the slides 50, two locking members 70 mounted between the support member 40 and the slides 50 to releasably lock the first support brackets 41 and the second support brackets 42 of the support member 40 onto the slides 50, and a seat 20 mounted on the support member 40.

The top tube 11 of the frame 10 is disposed at an inclined state.

The fixing member 30 has an elongated strip shape and has a lower portion 32 mounted on the top tube 11 of the frame 10 and an upper portion formed with a guide track 31 on which each of the slides 50 is slidable. The lower portion 32 of the fixing member 30 has a bottom formed with a substantially arc-shaped receiving recess 322 to receive an outer wall the top tube 11 of the frame 10 and has two opposite sides each formed with a plurality of riveting bores 320 to rivet the lower portion 32 of the fixing member 30 onto the top tube 11 of the frame 10. The guide track 31 of the fixing member 30 has a substantially dovetail-shaped cross-sectional profile.

The reclining cycle further comprises two mounting sleeves 60 each clamped between any two opposite slides 50 and each located above the guide track 31 of the fixing member 30, and each of the locking members 70 passes through a respective mounting sleeve 60.

Each pair of the slides 50 are slidable on two opposite sides of the guide track 31 of the fixing member 30. Each of the slides 50 has a side formed with a substantially dovetail-shaped sliding groove 51 slidable on the guide track 31 of the fixing member 30 and formed with a receiving space 520 to receive a respective mounting sleeve 60. Each of the slides 50 has a side formed with a through hole 52 to allow passage of a respective locking member 70. The receiving space 520 of each of the slides 50 is connected to the through hole 52 and has a diameter greater than that of the through hole 52.

The first pair of the slides 50 are clamped between the first support brackets 41 of the support member 40 and the guide track 31 of the fixing member 30, and the second pair of the slides 50 are clamped between the second support brackets 42 of the support member 40 and the guide track 31 of the fixing member 30.

The first support brackets 41 of the support member 40 are movable on the first pair of the slides 50. Each of the first support brackets 41 of the support member 40 extends downward from the support member 40 in an oblique manner and has an elongated guide slot 410 slidable on a respective locking member 70. The guide slot 410 of each of the first support brackets 41 is inclined relative to the support member 40. Each of the second support brackets 42 of the support member 40 extends downward from and is perpendicular to the support member 40 and has a pivot bore 420 pivotally mounted on a respective locking member 70.

Each of the locking members 70 is preferably a quick release locking member. Each of the locking members 70 is operable between a locked state in which the first support brackets 41 and the second support brackets 42 of the support member 40, the slides 50 and the guide track 31 of the fixing member 30 are locked by each of the locking members 70 so that the support member 40 and the slides 50 are locked onto the fixing member 30 and an unlocked state in which the first support brackets 41 and the second support brackets 42 of the support member 40, the slides 50 and the guide track 31 of the fixing member 30 are unlocked from each of the locking members 70 so that the slides 50 are movable on the fixing member 30, the first support brackets 41 of the support member 40 are movable on the first pair of the slides 50, and the second support brackets 42 of the support member 40 are pivotable on the second pair of the slides 50.

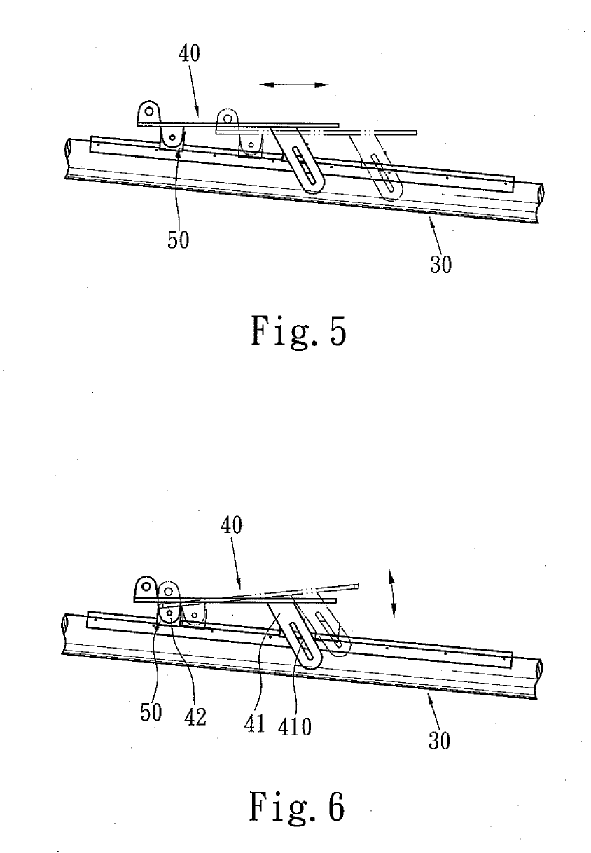

In operation, referring to FIGS. 5 and 6 with reference to FIGS. 1-4, when each of the locking members 70 is unlocked, the first support brackets 41 and the second support brackets 42 of the support member 40, the slides 50 and the guide track 31 of the fixing member 30 are unlocked from each of the locking members 70 so that the slides 50 are movable on the fixing member 30 as shown in FIG. 5 to change the position of the support member 40 relative to the fixing member 30 so as to adjust the position of the seat 20 relative to the frame 10. At the same time, the second support brackets 42 of the support member 40 are pivotable on the second pair of the slides 50, and the first support brackets 41 of the support member 40 are movable on the first pair of the slides 50 as shown in FIG. 6 to change the inclined angle of the support member 40 relative to the fixing member 30 so as to adjust the inclined angle of the seat 20 relative to the frame 10.

Accordingly, the position and the inclined angle of the seat 20 relative to the frame 10 can be adjusted according to a user's requirement to provide a comfortable sensation to the user when the user is seated on the seat 20. In addition, the support member 40 is locked and unlocked by each of the locking members 70 so that the position and the inclined angle of the seat 20 relative to the frame 10 can be adjusted easily and quickly, thereby facilitating the user adjusting the position and the inclined angle of the seat 20. Further, the lower portion 32 of the fixing member 30 has a bottom formed with a receiving recess 322 to receive the top tube 11 of the frame 10 so that the fixing member 30 is available for frames 10 of different sizes.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A reclining cycle, comprising:
a frame having a top tube;
a fixing member mounted on the top tube of the frame;
two pairs of slides slidably mounted on the fixing member;
a support member mounted on the slides to move with the slides and having a first end provided with two first support brackets adjustably mounted on a first pair of the slides and a second end provided with two second support brackets pivotally mounted on a second pair of the slides;
two locking members mounted between the support member and the slides to releasably lock the first support brackets and the second support brackets of the support member onto the slides;
a seat mounted on the support member.

2. The reclining cycle in accordance with claim 1, wherein the fixing member has an upper portion formed with a guide track on which each of the slides is slidable.

3. The reclining cycle in accordance with claim 2, wherein
the guide track of the fixing member has a substantially dovetail-shaped cross-sectional profile;
each of the slides has a side formed with a substantially dovetail-shaped sliding groove slidable on the guide track of the fixing member.

4. The reclining cycle in accordance with claim 2, further comprising two mounting sleeves each clamped between any two opposite slides.

5. The reclining cycle in accordance with claim 4, wherein each of the mounting sleeves is located above the guide track of the fixing member,

6. The reclining cycle in accordance with claim 4, wherein each of the locking members passes through a respective mounting sleeve.

7. The reclining cycle in accordance with claim 4, wherein each of the slides has a side formed with a receiving space to receive a respective mounting sleeve.

8. The reclining cycle in accordance with claim 7, wherein each of the slides has a side formed with a through hole to allow passage of a respective locking member.

9. The reclining cycle in accordance with claim 8, wherein the receiving space of each of the slides is connected to the through hole.

10. The reclining cycle in accordance with claim 8, wherein the receiving space of each of the slides has a diameter greater than that of the through hole.

11. The reclining cycle in accordance with claim 2, wherein each pair of the slides are slidable on two opposite sides of the guide track of the fixing member.

12. The reclining cycle in accordance with claim 2, wherein
the first pair of the slides are clamped between the first support brackets of the support member and the guide track of the fixing member;
the second pair of the slides are clamped between the second support brackets of the support member and the guide track of the fixing member.

13. The reclining cycle in accordance with claim 1, wherein the first support brackets of the support member are movable on the first pair of the slides.

14. The reclining cycle in accordance with claim 13, wherein
each of the first support brackets of the support member has an elongated guide slot slidable on a respective locking member;
each of the second support brackets of the support member has a pivot bore pivotally mounted on a respective locking member.

15. The reclining cycle in accordance with claim 14, wherein the guide slot of each of the first support brackets is inclined relative to the support member.

16. The reclining cycle in accordance with claim 1, wherein
each of the first support brackets of the support member extends downward from the support member in an oblique manner;
each of the second support brackets of the support member extends downward from and is perpendicular to the support member.

17. The reclining cycle in accordance with claim 2, wherein
each of the locking members is a quick release locking member;
each of the locking members is operable between a locked state in which the first support brackets and the second support brackets of the support member, the slides and the guide track of the fixing member are locked by each of the locking members so that the support member and the slides are locked onto the fixing member and an unlocked state in which the first support brackets and the second support brackets of the support member, the slides and the guide track of the fixing member are unlocked from each of the locking members so that the slides are movable on the fixing member, the first support brackets of the support member are movable on the first pair of the slides, and the second support brackets of the support member are pivotable on the second pair of the slides.

18. The reclining cycle in accordance with claim 1, wherein
the fixing member has a lower portion mounted on the top tube of the frame;
the lower portion of the fixing member has a bottom formed with a substantially arc-shaped receiving recess to receive an outer wall the top tube of the frame and has two opposite sides each formed with a plurality of riveting bores to rivet the lower portion of the fixing member onto the top tube of the frame.

19. The reclining cycle in accordance with claim 1, wherein the top tube of the frame is disposed at an inclined state.

20. The reclining cycle in accordance with claim 1, wherein the fixing member has an elongated strip shape.
